(19) United States
(12) Patent Application Publication
(10) Pub. No.: US 2008/0049012 A1
(43) Pub. Date: Feb. 28, 2008

(54) 3D Line-of-Sight (Los) Visualization in User Interactive 3D Virtual Reality Environments

(76) Inventors: Ittai Bar-Joseph, Shimshit (IL); Dror Ouzana, Haifa (IL); Eran Shefi, Nahatal (IL); Yorai Gabriel, Haifa (IL); Shay Peretz, Shimshit (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/570,571

(22) PCT Filed: Jun. 14, 2005
(86) PCT No.: PCT/IL05/00625

§ 371 Date: Dec. 13, 2006

(30) Foreign Application Priority Data
Jun. 13, 2004 (IL) 162480

(51) Int. Cl. G06T 15/00

(52) U.S. Cl. 345/419

(57) ABSTRACT

The present invention is for a decision support tool for 3D LOS visualization in user interactive 3D virtual reality environments for enabling true 3D LOS analysis for assisting decision making in a wide range of applications including inter alia land development projects, military operational planning, sensor placement in surveillance systems, and the like. The present invention further enables displaying cross sections of 3D virtual reality scenes, and determination of the minimum elevation of an origin node for ensuring a single continuous unobstructed 3D LOS with each target node of at least one stationary target node.

### FIELD OF THE INVENTION

The invention pertains to user interactive 3D virtual reality environments.

### BACKGROUND OF THE INVENTION

User interactive 3D virtual reality environments include 3D geometric objects typically displayed as textured wire frame models enabling a user to freely navigate in a user interactive 3D virtual reality scene for enabling, for example, to walk into natural structures or buildings and look upwards, to pass under natural structures and buildings and look upwards, and the like. Commercially off-the-shelf (COTS) 3D virtual reality engines for generating user interactive 3D virtual reality environments include inter alia Vega Prime commercially available from MultiGen Paradigm, Inc. (www.multigen.com), Legus 3D commercially available from 3D Software, Inc. (www.Legus3D.com), and the like. User interactive 3D virtual reality environments are employed for a wide range of applications including games, simulators, decision support tools, and the like.

U.S. Pat. No. 6,771,932 to Caminiti et al. employs LOS analysis on so-called 3D maps for implementing a transceiver based Free Space Optics (FSO) network. 3D maps are not 3D virtual reality scenes but rather 2D raster image maps generated from Digital Elevation Model (DEM) data in which each and every pixel is colored to represent its elevation or height at its corresponding X-Y coordinate. A user may define various parameters regarding the transceivers, for example, Maximum Link Length, and a LOS volume around a LOS. LOS volumes may have a rectangular cross segment, a cylindrical cross segment, and the like. LOS occlusion is determined in each instance that a LOS is lower at any point therealong than its corresponding 2D raster image map pixel. Thus, a LOS passing under a bridge would be incorrectly returned as being occluded since its height is less than the bridge's height at the point that it passes thereunder.

### SUMMARY OF THE INVENTION

Generally speaking, the present invention is directed toward a decision support tool for 3D (line-of-sight) LOS visualization in user interactive 3D virtual reality environments thereby providing true 3D LOS analysis for assisting decision making in a wide range of applications including inter alia land development projects, civil engineering projects, military operational planning, sensor placement in surveillance systems, and the like. The present invention further enables displaying 3D virtual reality scenes from different virtual camera viewpoints, and a vertical cross section of a 3D virtual reality scene in the direction of a 3D LOS for displaying different information. The vertical cross sections may include inter alia geospatial information, utility infrastructure information, architectural structures, and the like.

For the purpose of the present invention, a 3D LOS is a 3D vector between a pair of user determined spaced apart nodes placed on a 3D virtual reality scene. A 3D LOS is preferably determined by so-called ray tracing which involves extrapolating an infinite ray from a start position in 3D space along a 3D vector. A 3D LOS can be constituted by either a single continuous unobstructed 3D LOS segment or a single continuous obstructed LOS segment. Alternatively, a 3D LOS can be constituted by at least one unobstructed 3D LOS segment and at least one obstructed LOS segment therealong. The 3D changeover coordinates along a 3D LOS between an unobstructed 3D LOS segment and an obstructed 3D LOS segment can be determined by several techniques inter alia the intersection of a ray with a 3D geometric object, the use of a so-called z-Buffer, and the like. Obstructed 3D LOS segments are preferably visually displayed on a 3D virtual reality scene in a visually distinguishable manner from unobstructed 3D LOS segments.

### BRIEF DESCRIPTION OF THE DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a high level block diagram of a general purpose computer system for supporting 3D line-of-sight (LOS) visualization in user interactive 3D virtual reality environments and a Minimum Origin Node Elevation (MONE) module;

FIG. 2 is a schematic diagram showing a GUI depicting a 3D virtual reality scene including an origin node, four target nodes, and four lines-of-sight between the origin node and the four target nodes;

FIG. 3 is a flow diagram for 3D LOS visualization in a user interactive 3D virtual reality environment;

FIG. 4 is a schematic diagram showing a GUI depicting the 3D virtual reality scene from the origin node in FIG. 2 towards the easternmost target node of the four target nodes;

FIG. 5 is a schematic diagram showing a GUI depicting the 3D virtual reality scene from the easternmost target node of the four target nodes in FIG. 2 towards the origin node;

FIG. 6 is a schematic diagram showing a GUI depicting a vertical cross section of a 3D virtual reality scene along the direction of a 3D LOS including LOS length information;

FIG. 7 is a schematic diagram showing a GUI depicting a vertical cross section of a 3D virtual reality scene along the direction of a 3D LOS including information associated with the 3D LOS and a 3D virtual reality contour;

FIG. 8 is a schematic diagram showing a GUI depicting a vertical cross section of a 3D virtual reality scene along the direction of a 3D LOS showing geospatial information;

FIG. 9 is a flow diagram of the MONE module for determining the minimum elevation of an origin node for ensuring an unobstructed 3D LOS with each target node of at least one stationary target node;

FIG. 10 is a schematic diagram showing a GUI depicting a 3D virtual reality scene showing an origin node at an elevation H1 insufficiently high to ensure an unobstructed 3D LOS with each target node of three stationary target nodes;

FIG. 11 is a schematic diagram showing the origin node on FIG. 10's 3D virtual reality scene at an elevation H2>H1 but still insufficiently high to ensure an unobstructed 3D LOS with each target node of the three stationary target nodes; and

FIG. 12 is a schematic diagram showing the origin node on FIG. 10's 3D virtual reality scene at an elevation H3>H2 sufficiently high to ensure an unobstructed 3D LOS with each target node of the three stationary target nodes.

### DETAILED DESCRIPTION OF PREFERRED EMBODIMENTS OF THE PRESENT INVENTION

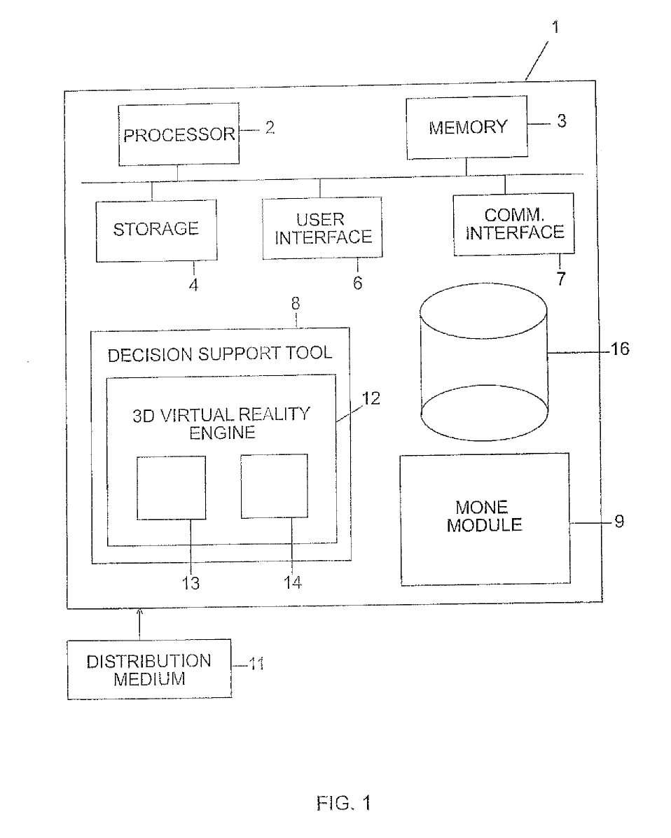

FIG. 1 shows a general purpose computer system 1 including a processor 2, system memory 3, non-volatile storage 4, a user interface 6 including a keyboard, a mouse, a display, and the like, and a communication interface 7. The constitution of each of these elements is well known and each performs its conventional function as known in the art and accordingly will not be described in greater detail. In particular, the system memory 3 and the non-volatile storage 4 are employed to store a working copy and a permanent copy of the programming instructions implementing the present invention. The permanent copy of the programming instructions to practice the present invention may be loaded into the non-volatile storage 4 in the factory, or in the field, through communication interface 7, or through distribution medium 11. The permanent copy of the programming instructions is capable of being distributed as a program product in a variety of forms, and the present invention applies equally regardless of the particular type of signal bearing media used to carry out distribution. Examples of such media include recordable type media e.g. CD ROM and transmission type media e.g. digital communication links. Although FIG. 1 is depicted as a general purpose computer system 1 that is programmed to perform various control functions in accordance with the present invention, the present invention can be implemented in hardware, for example, as an application specified integrated circuit (ASIC). As such, the process steps described herein are intended to be broadly interpreted as being equivalently performed by software, hardware, or a combination thereof.

The computer system 1 is capable of running a Decision Support Tool 8 for 3D LOS visualization in user interactive 3D virtual reality environments, and a Minimum Origin Node Elevation (MONE) module 9 for determining the minimum elevation of an origin node for ensuring a single continuous unobstructed 3D LOS with each target node of at least one stationary target node. The Decision Support Tool 8 includes a COTS 3D virtual reality engine 12 including a scene graph 13 and a renderer 14. Suitable COTS 3D virtual reality engines include inter alia Vega Prime commercially available from MultiGen Paradigm, Inc. (www.multigen.com), Legus 3D commercially available from 3D Software, Inc. (www.Legus3D.com), and the like. The Decision Support Tool 8 interfaces with a geo-database 16 including the information required for a particular application at hand. For example, the geo-database can include inter alia Digital Terrain Model (DTM) files, aerial imagery, Geographical Information System (GIS) data, land survey data, civil engineering and/or architectural structure CAD drawings, data extracted from aerial imagery using photogrammetry or other means, and the like. Suitable GIS data sources include inter alia ESRI, ShapeFiles, and the like. Suitable land survey data sources include inter alia REG files, DIS files, and the like. Suitable CAD data sources include inter alia Bentley DGN, Autodesk DWG files, and the like.

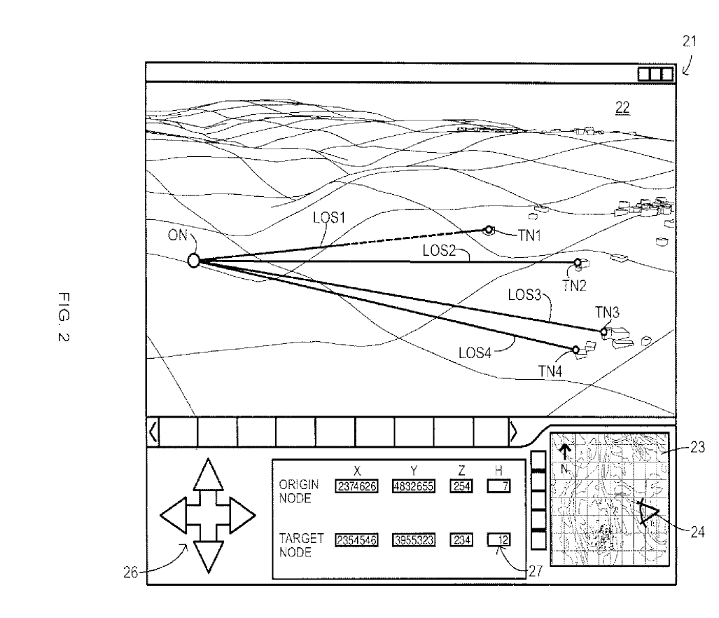

FIG. 2 shows a GUI 21 depicting a 3D virtual reality scene 22, a 2D bird's eye view orientation map 23 with an icon 24 indicating the location and direction of a virtual camera viewpoint for displaying the 3D virtual reality scene 22, and a navigation tool 26 for 3D navigation within the 3D virtual reality scene 22. A user can place an origin node ON and one or more target nodes TNs on the 3D virtual reality scene 22 either by clicking thereon using an input device, for example, a computer mouse, a touch pad, a GPS or land survey instrument, and the like, or by entering 3D coordinates in text fields 27. The 3D virtual reality scene 22 displays an origin node ON, and four target nodes TN1, TN2, TN3 and TN4, and their corresponding lines-of-sight LOS1, LOS2, LOS3 and LOS4 with the origin node ON. Unobstructed 3D LOS segments are shown in solid lines and obstructed 3D LOS segments are shown in dashed lines. In the present case, the 3D LOS LOS1 includes a central obstructed 3D LOS segment whilst 3D LOSs LOS2, LOS3 and LOS4 are unobstructed. Alternatively, unobstructed 3D LOS segments and obstructed 3D LOS segments can be color coded, for example, green for unobstructed 3D LOS segments and red for obstructed 3D LOS segments. Alternatively, they can be texture coded.

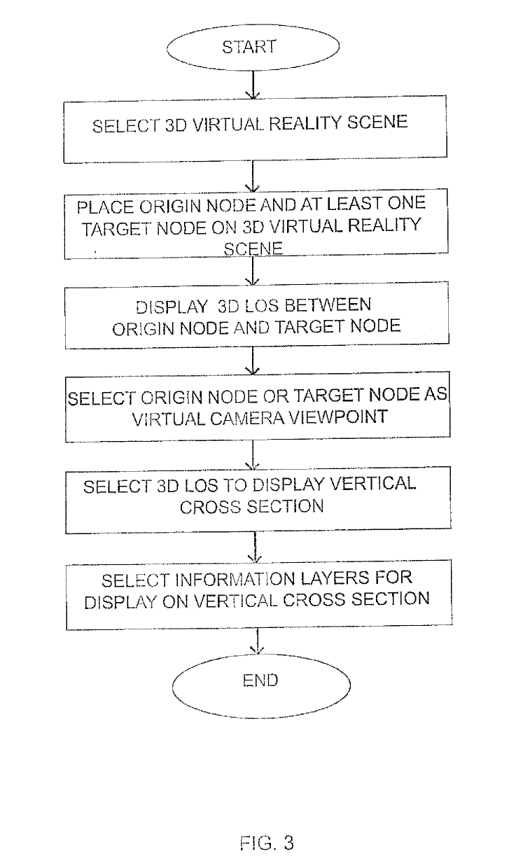

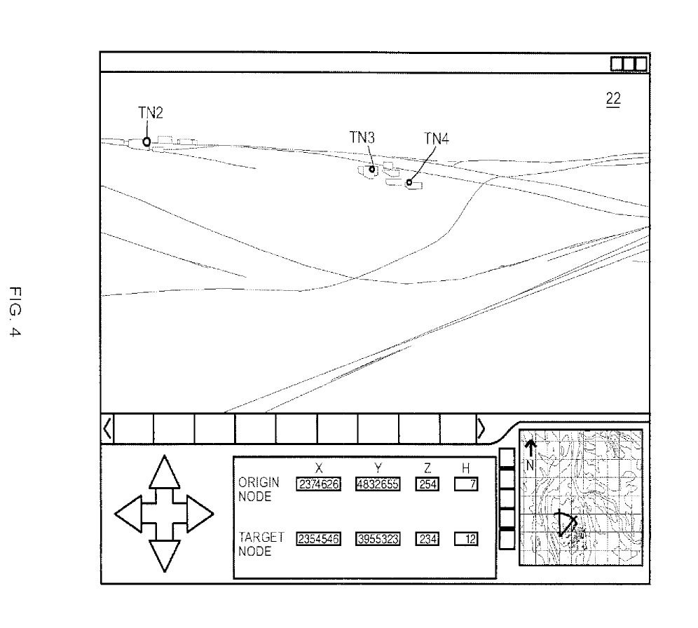

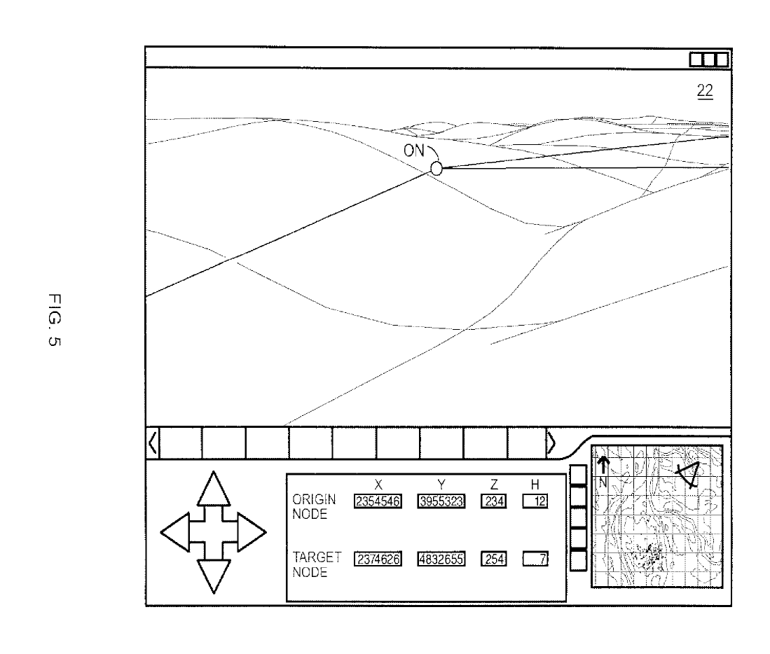

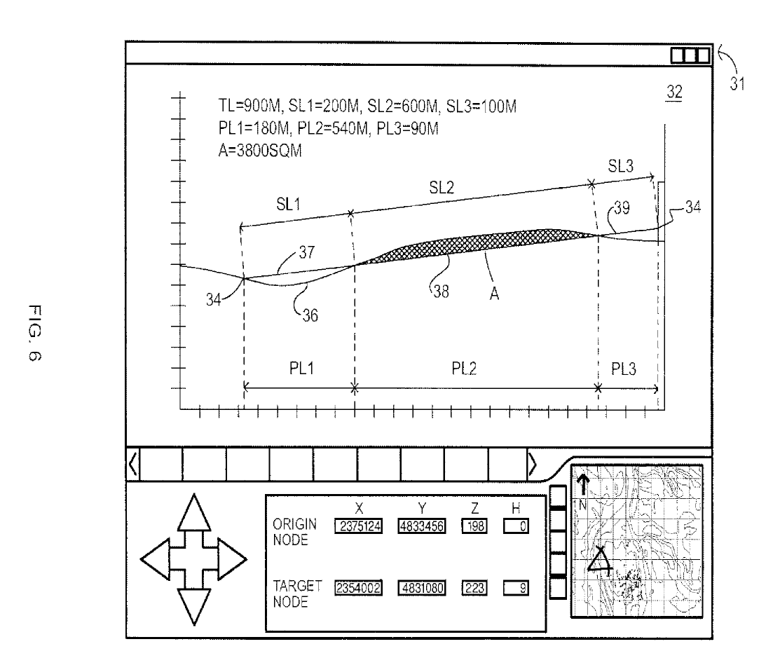

FIG. 3 is a flow diagram for 3D LOS visualization in a user interactive 3D virtual reality environment. A user selects a 3D virtual reality scene and places an origin node and one or more target nodes thereon. The DST 8 displays the 3D LOS between the origin node and each target node. A user can select to show a 3D virtual reality scene from an origin node or one of the target nodes by clicking on same. For example, FIG. 4 depicts the 3D virtual reality scene 22 from the origin node ON towards the easternmost target node TN4 whilst FIG. 5 depicts the 3D virtual reality scene 22 from the easternmost target node TN4 towards the origin node ON. A user can select to show vertical cross sections of 3D virtual reality scenes with different information. Some of the information can be retrieved from the geo-database 16 whilst other information can be calculated from a 3D virtual reality scene. FIGS. 6-8 show a GUI 31 depicting different vertical cross sections each including a 3D LOS extending between a pair of spaced apart nodes on a 3D virtual reality contour.

FIG. 6 shows a vertical cross section 32 with a 3D LOS 33 extending between spaced apart nodes 34 on a 3D virtual reality contour 36 for the purpose of, say, planning the route of a new highway from an approach road to the entrance of an existing tunnel. The 3D LOS 33 includes a leftmost unobstructed 3D LOS segment 37, a center obstructed 3D LOS segment 38, and a rightmost unobstructed 3D LOS segment 39. FIG. 6 also displays the following 3D LOS length information: total 3D LOS length denoted TL, and actual lengths of the three 3D LOS segments 37, 38 and 39 respectively denoted SL1, SL2 and SL3 where TL=SL1+SL2+SL3. FIG. 6 also displays projected lengths PL1, PL2 and PL3 of the three 3D LOS segments 37, 38, and 39, in the X-direction and the shaded area bounded by the 3D virtual reality contour 36 and the obstructed 3D LOS segment 38. In the present case, the shaded area provides an indication of how much top soil has to be removed.

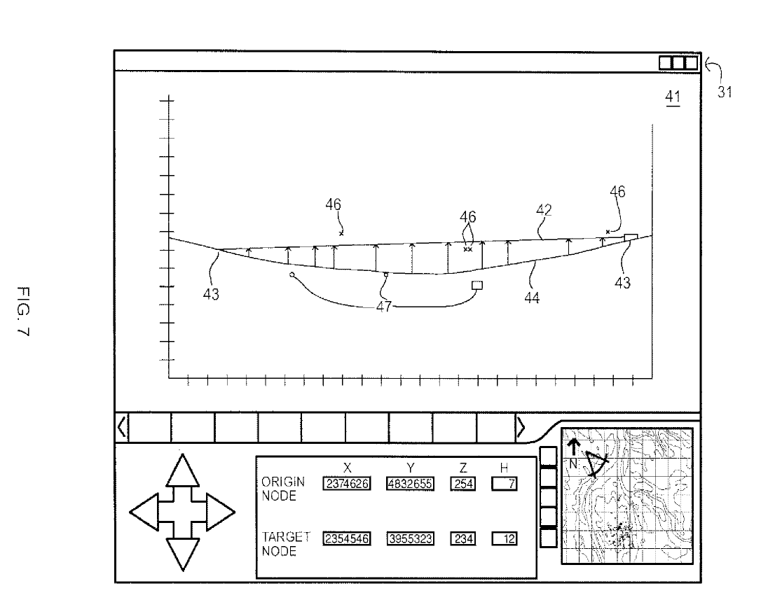

FIG. 7 shows a vertical cross section 41 with a single continuous unobstructed 3D LOS 42 extending between spaced apart nodes 43 on a 3D virtual reality contour 44 for the purpose of, say, planning the route of a new bridge. FIG. 7 also displays the heights between the 3D LOS 42 and the 3D virtual reality contour 44, and utility infrastructure information, for example, electricity pylons 46, and underground water mains and sewage pipes 47.

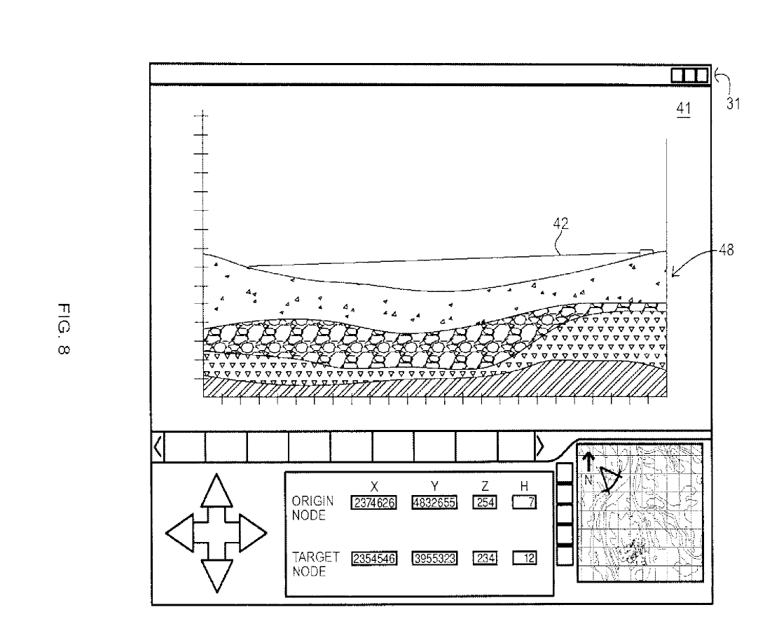

FIG. 8 shows the same vertical cross section 41 and geospatial information 48 regarding underlying rock formations.

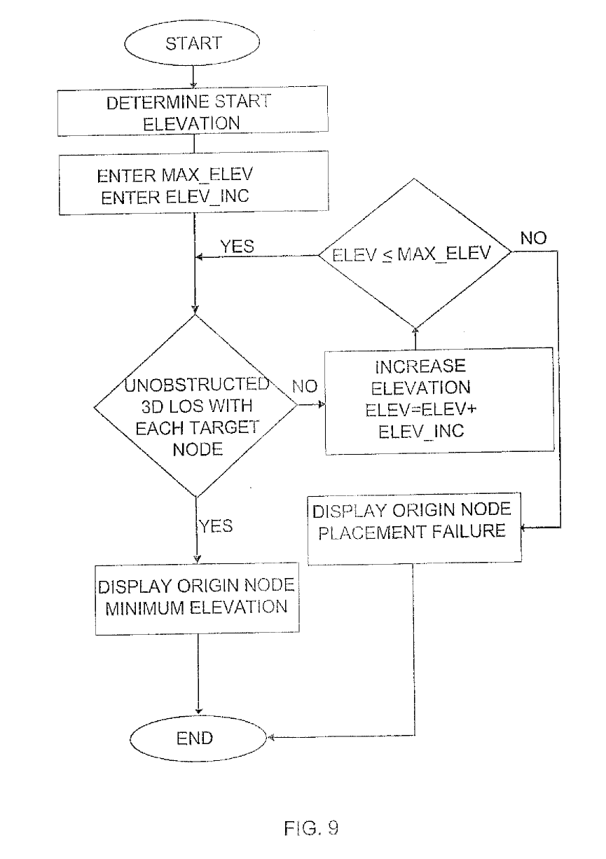

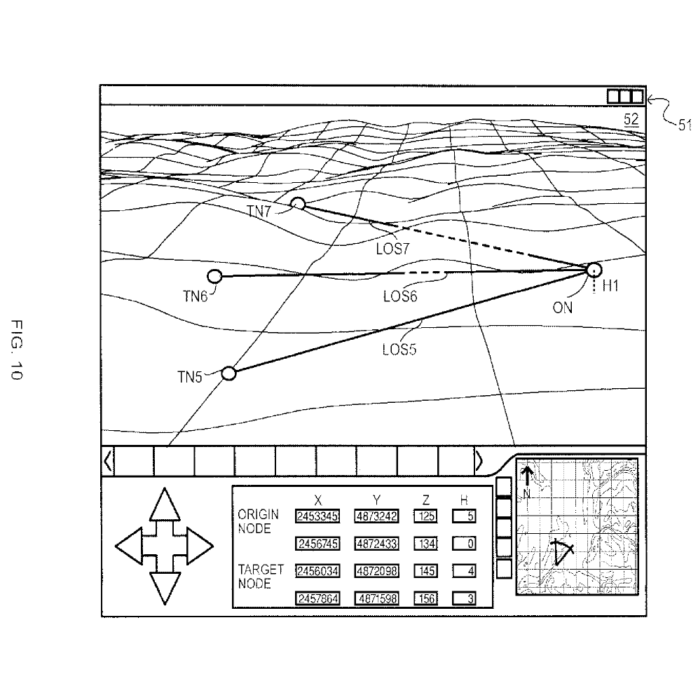

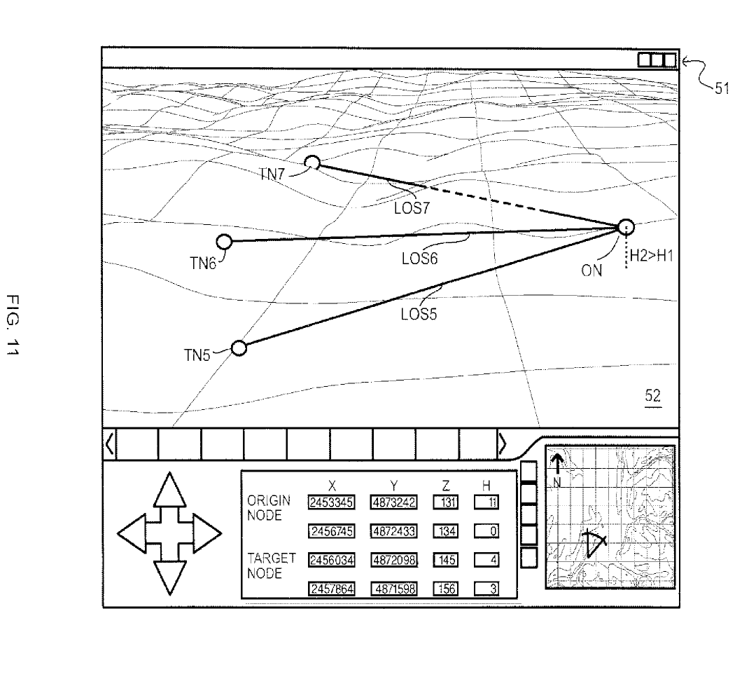

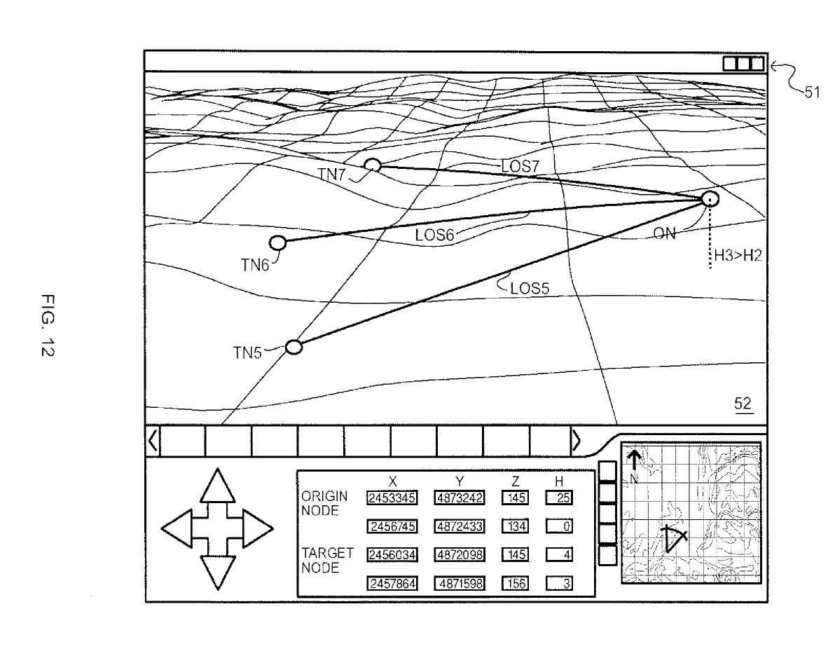

FIGS. 9-12 show the use of the Minimum Origin Node Elevation (MONE) module 9. FIG. 9 includes a step that a user is required to enter values for two arguments maximum elevation MAX_ELEV and an elevation increment ELEV_INCR. Alternatively, the MONE module 9 can be programmed to handle arguments maximum height above terrain and height increment. FIG. 10 shows a GUI 51 depicting a 3D virtual reality scene 52 with an origin node ON at an elevation H1=5 m, three stationary target nodes TN5, TN6, TN7, and three 3D LOSs including an unobstructed 3D LOS LOS5 with the target node TN5, an obstructed 3D LOS LOS6 with the target node TN6, and an obstructed 3D LOS LOS7 with the target node TN7. FIG. 11 depicts the 3D virtual reality scene 52 with the origin node ON at an elevation H2=11 m resulting in the previously obstructed 3D LOS LOS6 being unobstructed. FIG. 12 depicts the 3D virtual reality scene 52 with the origin node ON at an elevation H3=25 m resulting in all three 3D LOSs LOS5, LOS6, and LOS7 being unobstructed.

While the invention has been described with respect to a limited number of embodiments, it will be appreciated that many variations, modifications, and other applications of the invention can be made within the scope of the appended claims.

1. Method for 3D line-of-sight (LOS) visualization in a user interactive 3D virtual reality environment comprising the steps of:
(a) displaying a 3D virtual reality scene;
(b) determining a 3D LOS between a pair of user determined spaced apart nodes placed on the 3D virtual reality scene wherein the 3D LOS includes at least one unobstructed 3D LOS segment; and
(c) displaying at least the at least one unobstructed 3D LOS segment on the 3D virtual reality scene.

2. The method according to claim 1 wherein step (c) includes displaying an obstructed 3D LOS segment in a visually distinguishable manner from the at least one unobstructed 3D LOS segment.

3. The method according to claim 1 wherein step (c) includes displaying a 2D bird's eye view orientation map with an icon indicating the location and direction of a virtual camera viewpoint for viewing the 3D virtual reality scene.

4. The method according to claim 1 and further comprising the step of displaying the 3D virtual reality scene firm a virtual camera viewpoint at one node of the pair of spaced apart nodes towards the other node of the pair of spaced apart nodes.

5. The method according to claim 1 and further comprising the step of displaying a vertical cross section of the 3D virtual reality scene along direction of the 3D LOS.

6. The method according to claim 5 and further comprising the step of displaying 3D LOS length information.

7. The method according to claim 5 and further comprising the step of displaying information associated with the 3D LOS and a 3D virtual reality contour including the pair of spaced apart nodes.

8. The method according to claim 5 and further comprising the step of displaying geospatial information on the vertical cross section.

9. The method according to claim 1 and further comprising the step of determining the minimum elevation of an origin node for ensuring a single continuous unobstructed 3D LOS with each target node of at least one stationary target node.

10. A computer-readable medium having stored thereon a plurality of instructions, the plurality of instructions including instructions which, when executed by a processor, cause the processor to execute the steps comprising of:
(a) displaying a user interactive 3D virtual reality scene;
(b) determining a 3D LOS between a pair of user determined spaced apart nodes on the 3D virtual reality scene wherein the 3D LOS includes at least one unobstructed LOS segment; and
(c) displaying at least the at least one unobstructed 3D LOS segment on the 3D virtual reality scene.

11. The medium according to claim 10 wherein step (c) includes displaying an obstructed 3D LOS segment in a visually distinguishable manner from the at least one unobstructed 3D LOS segment.

12. The medium according to claim 10 wherein step (c) includes displaying a 2D bird's eye view orientation map with an icon indicating the location and direction of a virtual camera viewpoint for viewing the 3D virtual reality scene.

13. The medium according to claim 10 and further comprising the step of displaying the 3D virtual reality scene from a virtual camera viewpoint at one node of the pair of spaced apart nodes towards the other node of the pair of spaced apart nodes.

14. The medium according to claim 10 and further comprising the step of displaying a vertical cross section of the 3D virtual reality scene along the direction of the 3D LOS.

15. The medium according to claim 14 and further comprising the step of displaying 3D LOS length information.

16. The medium according to claim 14 and further comprising the step of displaying information associated with the 3D LOS and a 3D virtual reality contour including the pair of spaced apart nodes.

17. The medium according to claim 14 and further comprising the step of displaying geospatial information on the vertical cross section.

18. The medium according to claim 10 and further comprising the step of determining the minimum elevation of an origin node for ensuring a single continuous unobstructed LOS with each target node of at least one stationary target node.

19. Apparatus for 3D line-of-sight (LOS) visualization in a user interactive 3D virtual reality environment comprising:
(a) means for displaying a 3D virtual reality scene;
(b) means for determining a 3D LOS between a pair of user determined spaced apart nodes on the 3D virtual reality scene wherein the 3D LOS includes at least one unobstructed 3D LOS segment; and
(c) means for displaying at least the at least one unobstructed 3D LOS segment on the 3D virtual reality scene.

20. The apparatus according to claim 19 wherein the means for displaying at least the at least one unobstructed 3D LOS segment on the 3D virtual reality scene displays an obstructed 3D LOS segment in a visually distinguishable manner from the at least one unobstructed 3D LOS segment.

21. The apparatus according to claim 19 wherein the means for displaying at least the at least one unobstructed 3D LOS segment on the 3D virtual reality scene displays a 2D bird's eye view orientation map with an icon indicating the location and direction of a virtual camera viewpoint for viewing the 3D virtual reality scene.

22. The apparatus according to claim 19 and further comprising means for displaying the 3D virtual reality scene from a virtual camera viewpoint at one node of the pair of spaced apart nodes towards the other node of the pair of spaced apart nodes.

23. The apparatus according to claim 19 and further comprising means for displaying a vertical cross section of the 3D virtual reality scene along the direction of the 3D LOS. 24.

24. The apparatus according to claim 23 and further comprising means for displaying 3D LOS length information.

25. The apparatus according to claim 23 and further comprising means for displaying information associated with the 3D LOS and a 3D virtual reality contour including the pair of spaced apart nodes.

26. The apparatus according to claim 23 and further comprising means for displaying geospatial information on the vertical cross section.

27. The apparatus according to claim 19 and further comprising means for determining the minimum elevation of an origin node for ensuring a single continuous unobstructed 3D LOS with each target node of at least one stationary target node.
